(19) United States
(12) Patent Application Publication
(10) Pub. No.: US 2003/0167235 A1
(43) Pub. Date: Sep. 4, 2003

(54) Digital watermarking methods, programs and apparatus

(76) Inventors: Tyler J. McKinley, West Linn, OR (US); Philip R. Patterson, Sherwood, OR (US); Tony F. Rodriguez, Portland, OR (US)

Correspondence Address: DIGIMARC CORPORATION, 19801 SW 72ND AVENUE, SUITE 100, TUALATIN, OR, 97062, US

(21) Appl. No.: 10/265,085

(22) Filed: Oct. 3, 2002

Related U.S. Application Data
(60) Provisional application No. 60/327,687, filed on Oct. 5, 2001.

(51) Int. Cl. G06F 17/60

(52) U.S. Cl. 705/51

(57) ABSTRACT

The present invention provides various authentication and digital watermarking methods and apparatus. In one implementation, we use our techniques to authenticate clothing, e.g., flight jackets and designer clothing. The clothing includes machine-readable indicia, which is generally imperceptible to a human observer of the clothing. The method includes the steps of: i) providing the clothing to an optical sensor, which produces image data corresponding to the clothing; ii) analyzing the image data to detect the machine-readable indicia; and determining based at least in part on the machine-readable indicia whether the clothing is authentic.

### RELATED APPLICATION DATA

The present application claims the benefit of U.S. Provisional Patent Application No. 60/327,687, filed Oct. 5, 2001. The present application is also related to U.S. patent application Ser. No. 09/571,422, filed May 15, 2000 and Ser. No. 09/515,545, filed Feb. 29, 2000, and U.S. Pat. Nos. 6,324,573, 6,122,403 and 5,841,978. Each of these patent documents is herein incorporated by reference.

### BACKGROUND OF THE INVENTION

Digital watermarking technology, a form of steganography, encompasses a great variety of techniques by which plural bits of digital data are hidden in some other object, preferably without leaving human-apparent evidence of alteration.

Digital watermarking may be used to modify media content to embed a machine-readable code into the media content. The media may be modified such that the embedded code is imperceptible or nearly imperceptible to the user, yet may be detected through an automated detection process.

There are many processes by which media can be processed to encode a digital watermark. In physical objects, the data may be encoded in the form of surface texturing, or printing. Such marking can be detected from optical scan data, e.g., from a scanner or web cam. In electronic objects (e.g., digital audio or imagery—including video), the data may be encoded as slight variations in sample values. Or, if the object is represented in a so-called orthogonal domain (also termed “non-perceptual,” e.g., MPEG, DCT, wavelet, etc.), the data may be encoded as slight variations in quantization values or levels. The present Assignee's U.S. Pat. No. 6,122,403 and application Ser. No. 09/503,881 are illustrative of certain watermarking technologies.

Digital watermarking systems typically have two primary components: an embedding component that embeds a watermark in the media content, and a reading component that detects and reads the embedded watermark. The embedding component embeds a watermark pattern by altering data samples of the media content. The reading component analyzes content to detect whether a watermark pattern is present. In applications where the watermark encodes information, the reading component extracts this information from the detected watermark.

One problem that arises in many watermarking applications is that of object corruption. If the object is reproduced, or distorted, in some manner such that the content presented for watermark decoding is not identical to the object as originally watermarked, then the decoding process may be unable to recognize and decode the watermark. To deal with such problems, the watermark can convey a reference signal. The reference signal is of such a character as to permit its detection even in the presence of relatively severe distortion. Once found, the attributes of the distorted reference signal can be used to quantify the content's distortion. Watermark decoding can then proceed—informed by information about the particular distortion present.

The Assignee's U.S. patent application Ser. Nos. 09/503,881 and 09/452,023 detail certain reference signals, and processing methods, that permit such watermark decoding even in the presence of distortion. In some image watermarking embodiments, the reference signal comprises a constellation of quasi-impulse functions in the Fourier magnitude domain, each with pseudorandom phase. To detect and quantify the distortion, the watermark decoder converts the watermarked image to the Fourier magnitude domain and then performs a log polar resampling of the Fourier magnitude image. A generalized matched filter correlates the known orientation signal with the resampled watermarked signal to find the rotation and scale parameters providing the highest correlation. The watermark decoder performs additional correlation operations between the phase information of the known orientation signal and the watermarked signal to determine translation parameters, which identify the origin of the watermark message signal. Having determined the rotation, scale and translation of the watermark signal, the reader then adjusts the image data to compensate for this distortion, and extracts the watermark message signal as described above.

To provide a comprehensive disclosure without unduly lengthening this specification, each of the patents and patent applications cited in this specification are hereby incorporated by reference.

With the foregoing by way of background, the specification next turns to various digital watermarking improvements. It will be recognized that these improvements can typically be employed in many applications, and in various combinations with the subject matter of the patent documents cited herein. These improvements will be more readily apparent from the following detailed description.

### DETAILED DESCRIPTION

Product Cards

Theft of audio and video products from retail stores is a continuing concern. Millions of dollars are annually lost as shoplifters and other thieves walk out the front door with CDs, DVDs, etc. Anti-theft devices have curtailed theft—but at a significant packaging price.

Our improvements provide a relatively inexpensive solution to even further curtail theft and reduce manufacturing costs. Physical media, e.g., CDs, DVDs (audio and video), SACDs, mini-CDs, etc. that is typically found on store shelves is replaced with digitally watermarked cards (or other physical objects).

In one embodiment, product packaging, e.g., album covers, brochure, CD jewel cases or video jackets, etc., remains on store shelves for consumer perusal. A customer presents a product selection to a store clerk (or automated checkout process). The customer purchases a digitally watermarked card that is associated with the product selection. The association may be achieved through a digital watermark. In some cases the product package includes a digital watermark. The digital watermark is decoded from the product package and is used to identify or create an appropriate card.

The watermark encoding of the card can encompass artwork or printing on the card, the card's background, a laminate layer applied to the card, surface texture, etc. If a photograph or design is present, it too can be encoded. A variety of watermark encoding techniques are detailed in the patents and applications cited in this document; artisans in the field know many more. The digital watermark preferably includes a code or identifier.

The card is presented to a digital camera, scanner, optical sensor, or web camera to capture an image of the card. The captured image is analyzed by watermark detection software (or a hardware/software combination). The identifier is extracted by the watermark detector and the user's computer is directed to a target website. (Of course, the user computer can be directed to the website via information provided by a centralized router based on the identifier.). Assignee's U.S. patent Ser. No. 09/571,422, filed May 15, 2000, further describes methods for linking an object to an internet website or other network resource. Such linking methods are suitably interchangeable with this aspect of the present invention.

The target website preferably includes a digital copy of the album, song or video. The user downloads the album or video to her computer. The target website is optionally a private site, which means that the target website is assessable to users only via the watermarked card. In this case, copying or book marking the target website URL (or link) preferably will not enable user access to the website since the link is enabled by a central routing system that receives the watermark ID from a user computer. IP address checking and time stamping are some of the ways to help secure a private website. Assignee's U.S. patent application Ser. No. 09/853,835, filed May 10, 2001, and Ser. NO. 09/864,084, filed May 22, 2001, disclose still other techniques for securing a private website. Such website security techniques may be suitably interchanged with this aspect of the present invention.

The digital content can be further watermarked to help control unauthorized redistribution after downloading. The watermark may also include “self-destroy” instructions or a link to such instructions. For example, the watermark may include (or point to) an expiration date. The watermark will indicate, or help prohibit, rendering after expiration. Or the watermark may include an identifier that must correlate with the user's computer or rendering device. If the watermark does not match the device or computer, then play will be limited.

As an alternative security measure the number of permissible downloads is regulated. In this scenario, the watermarked card is preferable serialized, e.g., the watermark identifier uniquely identifies a particular card. The target website (or an associated database) records the number of downloads per identifier. When the limit is reached, the website prohibits access to the downloadable files.

In another implementation, a digitally watermarked card must be “activated” before linking is permitted. Theft of a digitally watermarked card is then useless, unless the card is first activated. A card can be activated in a number of ways. First, an authorized retailer (or distributor) is given a “master” card. This master card includes a digital watermark that is used to link the retailer to an activation website. (Alternatively, the retailer accesses the activation website in a conventional manner, e.g., via a URL and password login.). Once in communication with the activation website, the retailer presents the purchased watermarked card to an input device such as a digital camera, web camera, scanner, etc. An identifier is extracted via a watermark reader and the identifier is listed or otherwise flagged as an activated identifier. The user is then allowed to access the relevant content. The website can be unique to a particular artist (or label/manufacture). Or the content website (e.g., a target website) can be a centralized site representing many or all of the watermarked cards and content.

As a variation, the retailer associates content with a particular watermark identifier. In this case, watermarked cards are serialized (e.g., they include a unique identifier). However, the watermark identifiers are not assigned to specific content until the card is activated as discussed above. A retailer then selects an album, video, software or other content to be associated with the individual identifier.

As another variation, a purchaser activates a card, downloads the content, and/or selects content via a store kiosk. In this case the purchased content can be optionally downloaded directly from the kiosk to a rendering device (e.g., an MP3 player, CD-burner, or storage device).

Another benefit of a digitally watermarked card is ease of Internet navigation. After buying a card, a user can link directly to a site to download the album, song, video or software. This benefit disposes of the tedious task of typing in a long IP address or URL. To download a song by, e.g., Holly Tomas, one may have to navigate through a multiple web pages and ended up with address like:

http://play.mp3.com/play?redirect=play.mp3.com/cgi-bin/play/play.cgi/AAIBQiVaCABBAAAAAMA bm9ybVAEAAAAUrSYAQBRAQAA AAgAQ.OnMTt.etk7c8eOxJ_hAa8_XU_/love_the_way.m3u&refer-http%3A%2F%2Fa rtists.mp3s.com%2Fartists%2F104%2Fholly_jomas.html

The inventive watermark card provides a direct link to the desired content for downloading.

Another benefit is a significant reduction in manufacturing costs. Instead of reproducing millions of albums, videos or software on physical media (e.g., CDs, SACDs and DVDs), millions of digitally watermarked cards can be produced, at a fraction of the cost.

Audio Embedding

One inventive improvement involves embedding a digital watermark signal in an audio file or segment. The embedded digital watermark can be inserted in a precise audio location to mark a segment or time location of interest. Or an audio file can contain multiple watermarks spaced at predetermined intervals (e.g., a redundant watermark positioned every x seconds). Each watermark preferably includes a unique identifier; or the presence of a redundant watermark serves as a “mile marker” or counter. In this way, the watermark provides an index for the audio segments or file. This technique is beneficial for sound technicians, commercial users, or any other organization that may wish to index an audio file. Once an audio segment is watermarked, a watermark or specific watermark identifier is searched for (or the watermarks are “counted”) to find a desired audio segment, instead of listening to an entire audio file to find, e.g., a particular 5-second segment. Preferably, the watermark search is conducted digitally, which significantly reduces search time. This method also provides beneficial tracking information in the event that the audio signal is found in an unexpected distribution channel or location. In this case, the watermark can include a unique identifier, which is associated with a data record in a database. The data record includes information such as audio source, parties involved, authorized distribution channels, security levels, etc. Once extracted from the audio segment, the identifier is used to interrogate the database.

Watermarking Fabrics and Clothing

Assignee has disclosed, e.g., in U.S. patent application Ser. No. 09/697,009, that fabrics and clothing can be digitally watermarked. Watermarks can be embedded through fabric patterns, printed designs (e.g., on a T-shirt), printed logos, etc. In one improvement, clothing is digitally watermark to include a unique identifier. The identifier is associated with an employee, such as aircraft maintenance personal, flight crews, or security guards, just to name a few. The digital watermark is extracted from the clothing with a digital watermark reader and the identifier is used to interrogate a verification database. The database preferably includes information such as pictures, fingerprint data, biometric data, etc. to be used to verify the employee's identity.

In some implementations the clothing watermark or identifier is cross-correlated with an identifier (e.g., watermark, bar code, RIFD, etc.) carried by the employee. For example, the employee may have to provide her watermarked photo ID (e.g., see Assignee's U.S. Pat. No. 5,841,886 for details regarding watermarking photo IDs) for comparison with a watermark embedded in her flight or tarmac jacket before she is allowed entry to a restricted area. The watermarks are decoded and compared for authenticity or a match.

The absence of a clothing watermark may also be a clue that the clothing is not authentic.

In a related implementation, a digital watermark is embedded into clothing through a stitch or weave pattern. In other implementations, a particular stitching or weave process includes an identifiable pattern. The identifiable pattern yields a predictable signature when transformed to a frequency domain. This signature can be used for various purposes, including determining the angular orientation of the clothing when optically scanned (e.g., visible light scanning) and analyzed for the presence of a signature or watermark data.

Techniques for Adding Digital Watermarks to Photographic Film Products

Assignee's U.S. Pat. No. 6,122,403 describes a technique for pre-exposing film with a digital watermark. When a picture is captured on this pre-exposed film the digital watermark and picture combine to form a composite image with an embedded watermark. This digital watermark may carry a variety of information for an array of applications, as noted in the U.S. Pat. No. 6,122,403 and other watermarking literature.

An alternative method for applying a digital watermark to a film product is to insert a filter in the optical path of the camera, where the filter carries (or embeds) the digital watermark. This filter alters the luminance of light passing through it such that it embeds a digital watermark in the image formed on the film (in a conventional analog camera) or image sensors (in a digital camera). In particular, the fluctuations in luminance form a hidden digital watermark. This digital watermark carries auxiliary information, such as information about the camera, the photographer, the subject of the photograph, a copy control command, a unique identifier, etc.

One can create such a watermarking filter component by lightly printing a screen in the pattern of the digital watermark, and mounting that screen on a glass filter. This process may be implemented similarly to manufacturing an anti-glare layer of a polarization filter. The filter is then either permanently mounted in the optical system of a camera, or is interchangeably mounted as part of an attachment, such as an interchangeably lens unit.

The filter changes the luminance of an image captured through it, and these luminance changes imperceptibly embed the digital watermark signal in that image. In a conventional camera fitted with this filter, this digital watermarking method allows a negative to be embedded at exposure time. Also, it enables watermark embedding without the use of an electronic system. If the filter is fixed to the camera, it prevents the camera from producing unmarked images. However, by making the filter interchangeable, digital watermarks with different messages (or unique identifiers) may be embedded in the images captured using filters with different watermarks or different messages (or payloads).

The digital watermark signal may be created using techniques described in this document, as well as in U.S. Pat. No. 6,122,403 and Assignee's U.S. patent application Ser. No. 09/503,881. See also Assignee's U.S. patent application Ser. No. 09/800,093, for a disclosure of images acquired through an LCD optical shutter, or other programmable optical device, that imparts an inconspicuous patterning to the image as it is captured.

There are alternative methods for applying a watermark by pre-exposing film. Conventional un-exposed photographic film consists of a length of substrate formed into a roll. It is useful to have efficient methods for pre-exposing the digital watermark along the entire length of the film so that individual frames in the film are individually watermarked.

One approach is to use a barrel shaped object much like a motion picture film reel that has a “projector” inside it. The top and bottom is enclosed, but the entire side is either open or enclosed in glass. The center of this canister has three “projectors” that are connected to a server. The server is a computer that manages watermark identifier (ID) assignment for the film and supplies the digital watermark signal in the form of a digital watermark image carrying the appropriate watermark ID as its message payload. The digital watermark signal is repeatedly tiled across this image. (Alternatively, the watermark signal is embedded in precise locations in an image.). Each projector has a display view of 120 degrees. The number of projectors is irrelevant as long as they cover 360 degrees. As the film rolls by, the canister rolls at the same rate exposing the mark to the film. After enough film stock passes by to equal the 36 or 24 exposure roll, the digital watermark server advances to the next digital watermark (e.g., a digital watermark carrying the next unique identifier number) and projects this new mark as the film stock passes. This interchange happens continuously until the number of digitally watermarked rolls ordered is complete.

Another approach is to use a light table that is the length of the typical 36-exposure roll—it can extend to whatever the maximum length of film would be inside a canister. The table width needs to be no more than one film stock width. The machinery grabs the first few sprockets of the film length and pulls it to lie on top of the entire length of the table. The projector on the inside of the light table is connected to the digital watermark server, which supplies the digital watermark image carrying the appropriate ID as above. The projector projects the watermark signal along the length of the table.

In either case, the film production machine processes the hard copy unexposed film by very lightly exposing a digital watermark signal onto the negative/film. The film is spun and packaged as is normally done into the small black plastic canisters. The process can be designed such that each roll has a unique digital watermark, or similarly, so that each pack or group of X rolls has a unique watermark (where X is a selected integer number). The photographer takes normal pictures but inherent in the negative is the originally exposed watermark. This mark can be in any spectrum of color, and embedding in the luminance channel is one example.

This approach of watermarking film enables a variety of applications. For example, in one application, the film canister itself has the watermark ID number listed on it, or carried in a bar code or another digital watermark embedded in an image printed on the canister. The photographer accesses a registration server via a web site on the Internet and enters in the canister ID number—or simply holds the uniquely waternarked canister up to the camera, which extracts the canister ID from the watermark in the image on the canister. Once registered, the user instructs the server where to send his or her watermarked pictures after they are developed.

After using the roll of film, the photographer sends the roll to a photo developing service. The service identifies the photographer from the ID embedded in the images. In particular, it scans the images created from the exposed photographic film, extracts the watermark, including the ID, and sends the ID to the server via the Internet. The server, in turn, looks up the photographer's information supplied at registration time (e.g., name, address, account information and development preferences) and determines where to send the developed pictures, and which account to bill for the service. The developing service may send hard copy photos to a physical address, or electronic images to the photographer's on-line photo library or web site on the Internet. The photographer can then visit the web site to order prints, edit the digital versions of the images, etc.

### CONCLUSION

The foregoing are just exemplary implementations of the present invention. It will be recognized that there are a great number of variations on these basic themes. The foregoing illustrates but a few applications of the detailed technology. There are many others.

The section headings in this application are provided merely for the reader's convenience, and provide no substantive limitations. Of course, the disclosure under one section heading may be readily combined with the disclosure under another section heading.

To provide a comprehensive disclosure without unduly lengthening this specification, each of the above-mentioned patents and patent applications are herein incorporated by reference. The particular combinations of elements and features in the above-detailed embodiments are exemplary only; the interchanging and substitution of these teachings with other teachings in this application and the incorporated-by-reference patents/applications are expressly contemplated.

Many of the above-described methods and related functionality can be facilitated with computer executable software stored on computer readable media, such as electronic memory circuits, RAM, ROM, EPROM, flash memory, magnetic media, optical media, magnetic-optical media, memory sticks, hard disks, removable media, etc., etc. Such software may be stored and/or executed on a general-purpose computer, or on a server for distributed use. Also, instead of software, a hardware implementation, or a software-hardware implementation can be used.

In view of the wide variety of embodiments to which the principles and features discussed above can be applied, it should be apparent that the detailed embodiments are illustrative only and should not be taken as limiting the scope of the invention.

What is claimed is:

1. A method of doing business, the business related to selling or distributing media, said method comprising the steps of:
displaying media packaging or media information for examination by potential media purchasers, wherein the media packaging or information does not include the actual related media; and
presenting to a media purchaser a digitally watermarked object, wherein the object does not include the actual related media, but does include at least a digital watermark identifier which once decoded is used to link via the internet or a network to a server including storage, the storage including a digital version of the related media stored therein for download.

2. The method of claim 1, wherein the digital watermark identifier includes an expiration date.

3. The method of claim 1, wherein the media packaging or media information comprises a digital watermark including a media identifier.

4. The method of claim 3, wherein the object is identified by decoding the packaging or information digital watermark to obtain the media identifier, the media identifier identifying the object.

5. The method of claim 1, wherein the number of times the storage server is accessed via the watermarked object is monitored.

6. The method of claim 5, wherein access to the storage server is restricted after a predetermined number of access attempts that are associated with the watermarked object.

7. The method of claim 1, wherein a routing server is initially accessed via the watermarked object, the routing server redirecting an inquiry to the storage server.

8. A method of indexing audio content to locate a particular audio segment or time position, the content including a digital watermark embedded therein, said method being characterized by analyzing the audio content with a digital watermark detector to find the digital watermark that is embedded at the audio segment or time position, and accessing the audio content at the position marked by the digital watermark.

9. A method of authenticating clothing, the clothing including machine-readable indicia, the indicia being generally imperceptible to a human observer of the clothing, said method comprising the steps of:
providing the clothing to an optical sensor, the optical sensor producing image data corresponding to the clothing;
analyzing the image data to detect the machine-readable indicia; and
determining based at least in part on the machine-readable indicia whether the clothing is authentic.

10. The method of claim 9, wherein the machine-readable indicia comprises a digital watermark.

11. The method of claim 9, wherein the watermark includes an identifier that is used to link to a data repository, the data repository including identifying information for the owner or authorized possessor of the clothing.

12. The method of claim 11, wherein the identifying information comprises at least one of a group consisting of a photo, fingerprint, employee number and biometric identifier.

13. The method of claim 9, wherein said determining step comprises cross-correlating the machine-readable indicia with information carried by an employee badge or photo-identification document.

14. The method of claim 13, wherein the information is carried by the employee badge or photo-identification badge via machine-readable indicia.

15. The method of claim 14, wherein the machine-readable indicia carried by the employee badge or photo-identification comprises a digital watermark.

16. The method of claim 9 wherein the machine-readable indicia comprises a stitch pattern or clothing material weave, wherein the pattern or weave comprises a predetermined signature when transformed to a frequency domain.

17. A method of applying a digital watermark to a film product, the film product receiving light from an optical path of a camera, said method being characterized by providing light to an optical path of the camera, and providing a filter in the optical path of the camera, wherein the filter alters the luminance of light passing through the filter so as to embed a hidden digital watermark in an image formed on the film.

18. The method of claim 17, wherein fluctuations in luminance caused by said filter form the hidden digital watermark.

19. The method of claim 17, where the digital watermark carries auxiliary information, the auxiliary information comprising at least one related to the camera, photographer, a subject of a photograph, a copy control command, and a unique identifier.

20. The method of claim 17, wherein the filter comprises a generally transparent screen mounted to a glass lens, the screen including a pattern of the digital watermark.

21. The method of claim 20, wherein the filter is interchangeably attachable to the camera.

22. The method of claim 17, wherein the digital watermark is used as a link to related information.

23. A method of applying a digital watermark to an image optically captured via a camera, the camera comprising an image sensor receiving light from an optical path, said method being characterized by providing light to the optical path of the camera; and providing a filter in the optical path of the camera, wherein the filter alters the luminance of light passing through the filter so as to embed a hidden digital watermark in an image representation as presented to the image sensors.
